(19) United States
(12) Patent Application Publication
(10) Pub. No.: US 2025/0162900 A1
(43) Pub. Date: May 22, 2025

(54) HALOGEN-FREE MXENE AND METHOD FOR MANUFACTURING SAME

(71) Applicant: KOREA INSTITUTE OF SCIENCE AND TECHNOLOGY, Seoul (KR)

(72) Inventors: Taegon OH, Seoul (KR); Jaeeun YOON, Seoul (KR); Seong Chan KIM, Seoul (KR); Hyo Jin LEE, Seoul (KR); Albert LEE, Seoul (KR); Seon Joon KIM, Seoul (KR); Seung Sang HWANG, Seoul (KR); Chong Min KOO, Seoul (KR)

(73) Assignee: KOREA INSTITUTE OF SCIENCE AND TECHNOLOGY, Seoul (KR)

(21) Appl. No.: 18/824,778

(22) Filed: Sep. 4, 2024

(30) Foreign Application Priority Data
Nov. 20, 2023 (KR) 10-2023-0160327

(51) Int. Cl. C01G 23/00

(52) U.S. Cl. CPC C01G 23/002; C01P 2002/74; C01P 2002/84; C01P 2004/03

(57) ABSTRACT

The present invention provides a halogen-free MXene represented by the following formula (1), that has no halogen in its surface functional group by performing an etching process to generate MXene from a MAX Phase material, and after the etching process, performing an impurity removal treatment process of etching and removing impurities using a halogen-free etchant and a halogen-free post-treatment agent, respectively.

Mₙ₊₁XₙTₓ [Formula 1]
wherein, M is a transition metal element selected from the group consisting of Sc, Ti, V, Cr, Mn, Y, Zr, Nb, Mo, Hf, and Ta, X is at least one of carbon and nitrogen, and n is an integer from 1 to 4, and Tₓ is a functional group selected from the group consisting of oxygen, alkoxide of 1 to 5 carbon atoms, alkyl, carboxylate, hydroxide, hydride, oxide, sub-oxide, nitride, sub-nitride, sulfide, sulfonate, thiol, and epoxide.

### CROSS REFERENCE TO RELATED APPLICATION

The present application claims the benefit under 35 USC 119(a) of Korean Patent Application No. 10-2023-0160327 filed on Nov. 20, 2023, in the Korean Intellectual Property Office, the entire disclosure of which is incorporated herein by reference for all purposes.

### BACKGROUND OF THE INVENTION

### 1. Field of the Invention

The present invention relates to a halogen-free MXene with improved stability due to the absence of halogen elements on its surface, and a method for manufacturing the same.

### 2. Description of the Related Art

MXene is a two-dimensional material obtained from a MAX phase with a three-dimensional crystal structure consisting of M layer, A layer, and X layer. In 2011, a research team led by Professor Michel W. Barsoum at Drexel University succeeded in transforming a three-dimensional titanium-aluminum carbide, the MAX phase, into a two-dimensional structure with completely different properties by selectively removing an aluminum layer therefrom using a hydrofluoric acid. The research team named the two-dimensional material obtained by exfoliating the MAX phase as “MXene.” The MXene has electrical conductivity and strength similar to those of a graphene, and is known to be available to a variety of application technologies ranging from energy storage devices to biomedical applications, electromagnetic wave shielding, and composites.

The MXene can also be obtained by using a strong acid such as a hydrofluoric acid or a hydrochloric acid as an etchant for the MAX phase material. However, the strong acid such as the hydrofluoric acid or the hydrochloric acid used in synthesis of the MXene is harmful to the health of workers and generates by-products containing halogen elements, thereby increasing the cost of chemical waste disposal.

Further, the MXene material synthesized with the hydrofluoric acid and the hydrochloric acid-based etchants contains halogen elements as a surface functional group, and these halogen elements make the MXene material highly reactive. Therefore, the MXene, which has high reactivity, has low oxidation stability, and decomposes into a metal oxide and an amorphous carbon as time elapses, making long-term storage almost impossible.

Furthermore, when the MXene containing the halogen elements is oxidized and decomposed, halogen ions are released on its surface, which may cause contamination and malfunction of electronic devices to which the MXene is applied. Additionally, in case the MXene is applied to biosensors, etc., there is a problem that the halogen ions released from the surface of MXene may cause cytotoxicity.

### SUMMARY OF THE INVENTION

A first purpose of the present invention is to provide a halogen-free MXene that does not have a harmful effect on the health of workers by not using a strong acid such as a hydrofluoric acid or a hydrochloric acid during its manufacturing process, and a method for manufacturing the same.

A second purpose of the present invention is to provide a halogen-free MXene that has excellent chemical stability and oxidation stability and does not decompose easily over time to allow for long-term storage, and a method for manufacturing the same.

A third purpose of the present invention is to provide a halogen-free MXene that does not cause contamination or malfunction of electronic devices due to halogen ions even when used in the electronic devices, and does not cause cytotoxicity even when applied to biological electronic devices such as biosensors; and a method for manufacturing the same.

In order to achieve the purposes of the present invention, the present invention provides a halogen-free MXene represented by the following formula (1), that has no halogen in its surface functional group by performing an etching process to generate MXene from a MAX phase material, and after the etching process, performing an impurity removal treatment process of etching and removing impurities using a halogen-free etchant and a halogen-free post-treatment agent, respectively.

Mₙ₊₁XₙTₓ [Formula 1]
wherein, M is a transition metal element selected from the group consisting of Sc, Ti, V, Cr, Mn, Y, Zr, Nb, Mo, Hf, and Ta, X is at least one of carbon and nitrogen, and n is an integer from 1 to 4, and Tₓ is a functional group selected from the group consisting of oxygen, alkoxide of 1 to 5 carbon atoms, alkyl, carboxylate, hydroxide, hydride, oxide, sub-oxide, nitride, sub-nitride, sulfide, sulfonate, thiol, and epoxide.

The MXene may be formed of a single layer.

In order to achieve the above purposes, the present invention also provides a method for manufacturing a halogen-free MXene, comprising a first step of mixing a saturated sodium hydroxide solution with a MAX phase material and heat treating the same; and a second step of removing impurities by treating a product obtained after the heat treatment with a halogen-free post-treatment agent.

The MAX phase material may be a material represented by the following formula 2.

Mₙ₊₁AXₙ [Formula 2]
wherein, M is a transition metal element selected from the group consisting of Sc, Ti, V, Cr, Mn, Y, Zr, Nb, Mo, Hf, and Ta, and A is a metal element selected from the group consisting of Al, Si, P, Ga, Ge, As, Cd, In, Sn, Sb, Tl, and Pb, X is at least one of carbon and nitrogen, and n is an integer from 1 to 4.

The first step may include etching the MAX phase material at a high temperature of 200° C. or higher using the halogen-free etchant.

The halogen-free etchant may be a saturated sodium hydroxide solution with a concentration of 60 to 90%.

The first step may be performed at a temperature of 200 to 350° C. for a period of 24 hours or more to less than 96 hours.

The second step may be performed for 5 to 30 minutes using the halogen-free post-treatment agent selected from the group consisting of nitric acid, sulfuric acid, and phosphoric acid.

After the second step, the method of the present invention may further comprise a third step of performing exfoliation of a single layer by adding an organic solvent selected from the group consisting of DMSO (Dimethylsulfoxide), TMAOH (Tetramethylammonium hydroxide), and TBAOH (Tetrabutylammonium hydroxide) to the halogen-free MXene from which the impurities have been removed.

The third step may be performed at a temperature of 25 to 45° C. for 3 to 5 hours.

### BRIEF DESCRIPTION OF THE DRAWINGS

FIG. 1 is a conceptual diagram showing a process for manufacturing a halogen-free MXene according to an embodiment of the present invention.

FIG. 2 is a flowchart showing a process for manufacturing a halogen-free MXene according to an embodiment of the present invention.

FIG. 3 is an energy-dispersive X-ray spectroscopy (EDS) showing Na contents of a MXene surface before (a) and after (b) acid treatment, a XRD graph (c) of the MXene surface before and after the acid treatment, a MXene solution (d) in which exfoliated MXene is dispersed in water, a MXene film (e) made from the exfoliated MXene, a SEM image (f) of single layer MXene, and a TEM images (g, h) of the single layer MXene, in a process for manufacturing a halogen-free MXene according to an embodiment of the present invention.

FIG. 4 is graphs showing the results of X-ray photoelectron spectroscopy (XPS) experiments on a MXene produced by a process for manufacturing a halogen-free MXene according to an embodiment of the present invention and a conventional MXene.

FIG. 5 is images (a) showing contact angle, a UV-vis absorption peak graph (b), and a Ultraviolet Photoelectron Spectroscopy graph (c) of a MXene surface produced by a process for manufacturing a halogen-free MXene according to an embodiment of the present invention.

FIG. 6 is data such as halogen concentration graphs and graphs showing ion chromatograph values which indicate the results of biotoxicity experiments on a MXene produced by a process for manufacturing a halogen-free MXene according to an embodiment of the present invention and a conventional MXene.

FIG. 7 is UV-vis absorption peak graphs comparing oxidation stability on a MXene produced by a process for manufacturing a halogen-free MXene according to an embodiment of the present invention and a conventional MXene.

FIG. 8 is a table showing XRD graphs, peak areas, MXene contents, and the like, which indicate a change in the crystal structures of MXene and MAX for checking an etched degree of a MXene surface over time in a process for manufacturing a halogen-free MXene according to an embodiment of the present invention.

FIG. 9 is XRD graphs showing a degree of impurity production depending on a concentration of sodium hydroxide in a process for manufacturing a halogen-free MXene according to an embodiment of the present invention.

FIG. 10 is XRD graphs showing a change in the XRD peak of MXene at each step of synthesis in a process for manufacturing a halogen-free MXene according to an embodiment of the present invention.

FIG. 11 is a table showing impurity contents before and after removal of impurities and before and after heat treatment in a process for manufacturing a halogen-free MXene according to an embodiment of the present invention.

FIG. 12 is a UV-vis absorption peak graph, a photograph of low/high concentration solutions, and a SEM image which show the synthesis of NaOH—Ti₃CNTₓ MXene in the form of exfoliated flakes on Ti₃AlCN MAX phase where an element corresponding to A layer on the MAX phase is Al in a process for manufacturing a halogen-free MXene according to an embodiment of the present invention.

FIG. 13 is a UV-vis absorption peak graph, a photograph of low/high concentration solutions, and a SEM image which show the synthesis of NaOH—Ti₂CTₓ MXene in the form of exfoliated flakes on Ti₃AlC₂ MAX phase where an element corresponding to A layer on the MAX phase is Al in a process for manufacturing a halogen-free MXene according to an embodiment of the present invention.

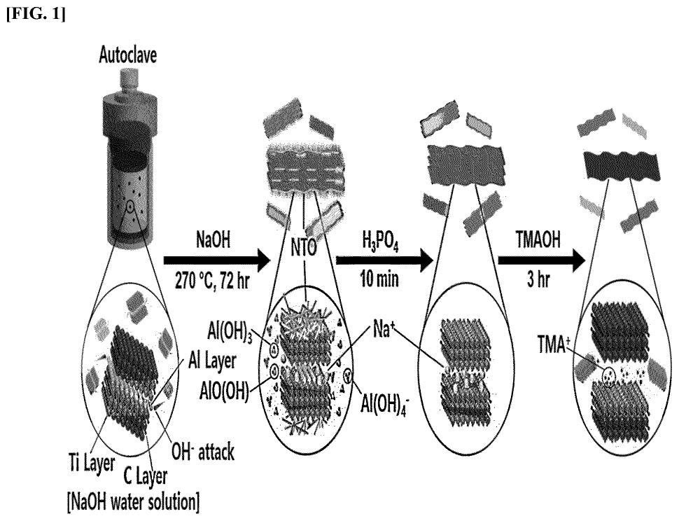

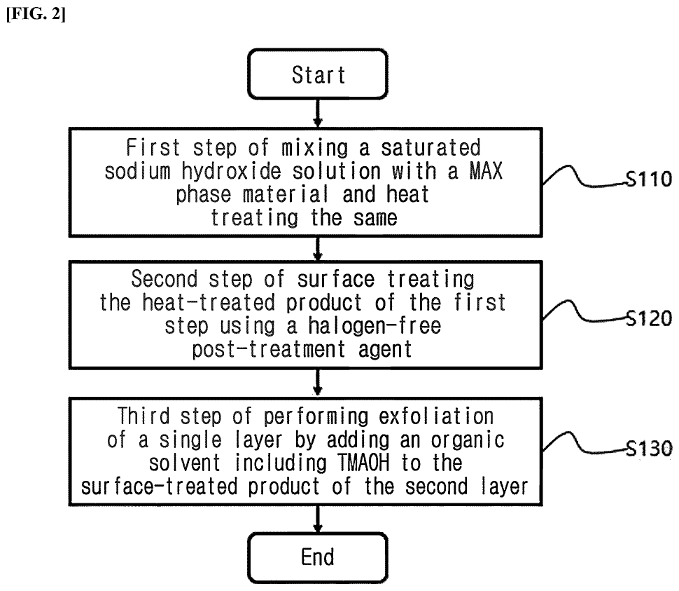

### DETAILED DESCRIPTION OF THE INVENTION

Hereinafter, a halogen-free MXene and a manufacturing method thereof related to the present invention will be described in more detail with reference to the drawings.

A halogen-free MXene according to an embodiment of the present invention can be represented by the following formula (1) that has no halogen in its surface functional group by performing an etching process to generate MXene from a MAX phase material, and after the etching process, performing an impurity removal treatment process of etching and removing impurities using a halogen-free etchant and a halogen-free post-treatment agent, respectively.

Mₙ₊₁XₙTₓ [Formula 1]
wherein, M is a transition metal element selected from the group consisting of Sc, Ti, V, Cr, Mn, Y, Zr, Nb, Mo, Hf, and Ta, X is at least one of carbon and nitrogen, and n is an integer from 1 to 4, and Tₓ is a functional group selected from the group consisting of oxygen, alkoxide of 1 to 5 carbon atoms, alkyl, carboxylate, hydroxide, hydride, oxide, sub-oxide, nitride, sub-nitride, sulfide, sulfonate, thiol, and epoxide.

In other words, since the halogen-free MXene according to the present invention is manufactured by etching and removing impurities with a halogen-free etchant and a halogen-free post-treatment agent in the process of manufacturing the MXene from the MXene phase material, it is characterized by the absence of halogens such as fluoride (F), chloride (CI), bromide (Br), and iodide (I) that may exist on the surface of conventional MXene. Therefore, the surface of MXene is relatively stabilized and has excellent oxidation stability, so that it does not decompose into a metal oxide and an amorphous carbon even when stored for a long time and can maintain a high preservation state.

In addition, since the halogen-free MXene does not contain halogen elements on its surface, it has an advantage that can prevent contamination or malfunction of electrochemical devices due to halogen ion emission even when applied to the electrochemical devices such as semiconductor devices, batteries, capacitors, and photoelectric devices.

Moreover, since the halogen-free MXene does not contain halogen and thus exhibits high biocompatibility, it can be applied to various technical fields such as biosensors, neural electrodes, biomedical polymers, and implant materials that can be applied to a human body.

The MAX phase material may be a material represented by the following formula 2.

Mₙ₊₁AXₙ [Formula 2]
wherein, M is a transition metal element selected from the group consisting of Sc, Ti, V, Cr, Mn, Y, Zr, Nb, Mo, Hf, and Ta, and A is a metal element selected from the group consisting of Al, Si, P, Ga, Ge, As, Cd, In, Sn, Sb, Tl, and Pb, X is at least one of carbon and nitrogen, and n is an integer from 1 to 4.

The halogen-free etchant may be a basic material that generates ions capable of nucleophilic attack on the MAX phase material, and may be, for example, a material selected from the group consisting of potassium hydroxide (KOH), ammonium hydroxide (NH₄OH), and sodium hydroxide (NaOH). Specifically, the halogen-free etchant may be sodium hydroxide (NaOH). Herein, the sodium hydroxide may be used in the form of a saturated solution with a concentration of 60 to 90%.

The MXene manufactured using the halogen-free etchant, which is a supersaturated solution of sodium hydroxide (NaOH), can be defined as, for example, MXene as shown in the following formula 3.

NaOH-Mₙ₊₁XₙTₓ [Formula 3]
wherein, M is a transition metal element selected from the group consisting of Sc, Ti, V, Cr, Mn, Y, Zr, Nb, Mo, Hf, and Ta, X is at least one of carbon and nitrogen, and n is an integer from 1 to 4, and Tₓ is a functional group selected from the group consisting of oxygen, alkoxide of 1 to 5 carbon atoms, alkyl, carboxylate, hydroxide, hydride, oxide, sub-oxide, nitride, sub-nitride, sulfide, sulfonate, thiol, and epoxide.

More specifically, the MXene may be formed as MXene of NaOH—Ti₃C₂Tₓ type.

The halogen-free post-treatment agent acts to neutralize the surface of MXene etched by the basic halogen-free etchant, and perform further exfoliation and processing of the MXene more smoothly by removing impurities such as aluminum hydroxide and NTO composites (compounds containing elements selected from the group consisting of sodium (Na), titanium (Ti), and oxygen (O)) with low water solubility present on the surface of MXene. This halogen-free post-treatment agent may be selected from the group consisting of, for example, nitric acid, sulfuric acid, and phosphoric acid.

The halogen-free MXene may also be formed into a thinner and lighter MXene by, for example, exfoliating it with an organic solvent selected from the group consisting of DMSO (Dimethylsulfoxide), TMAOH (Tetramethylammonium hydroxide), and TBAOH (Tetrabutylammonium hydroxide) to form MXene of a single layer. For example, by intercalating TMA⁺ cations using TMA in Ti₃C₂Tₓ MXene from which impurities have been removed, multi-layer Ti₃C₂Tₓ MXene can be exfoliated into single layer Ti₃C₂Tₓ MXene.

For reference, the MXene can be synthesized into a film only in case it is exfoliated, and the exfoliated MXene can be used in the form of solution by dispersing it in water. Further, if the MXene is not exfoliated, the liquid dispersion and film synthesis may become difficult.

The present invention also provides a method for manufacturing a halogen-free MXene, comprising a first step of mixing a saturated sodium hydroxide solution with a MAX phase material and heat treating the same; and a second step of removing impurities by treating a product obtained after the heat treatment with a halogen-free post-treatment agent.

The method for manufacturing the halogen-free MXene according to the present invention is carried out in a simple and convenient process of heat-treating the MXene in a single reactor using the saturated sodium hydroxide solution without using compounds containing halogen elements and removing impurities using the halogen-free post-treatment agent, compared to the conventional method of manufacturing MXene, which is carried out by a process of etching the MAX phase material using fluorine-containing compounds such as lithium fluoride (LiF), sodium fluoride (NaF), and magnesium fluoride (MgF₂) or strong acids such as chlorofluoric acid (HF), hydrochloric acid (HCl), and sulfuric acid (HSO₄). Therefore, the method according to the present invention does not have a harmful effect on the health of workers, and makes it possible to manufacture the MXene of a high purity more quickly with the impurities removed.

The first step may be performed in a hydrothermal reactor having a pressure of 1 to 10 bar at a temperature of 200 to 350° C. for a period of 24 hours or more to less than 96 hours. The hydrothermal reactor used in this first step may be, for example, a batch-type hydrothermal synthesis reactor equipped with a cover, a leakage prevention device, and a stirring impeller on the main body.

The second step may be performed for 5 to 30 minutes using the halogen-free post-treatment agent selected from the group consisting of nitric acid, sulfuric acid, and phosphoric acid.

Further, after the second step, the method of the present invention may further comprise a third step of performing exfoliation of a single layer by adding an organic solvent selected from the group consisting of DMSO (Dimethylsulfoxide), TMAOH (Tetramethylammonium hydroxide), and TBAOH (Tetrabutylammonium hydroxide) to the halogen-free MXene from which the impurities have been removed. This third step may be performed at a temperature of 25 to 45° C. for 3 to 5 hours.

Hereinafter, with reference to Examples and Drawings, the halogen-free MXene and its manufacturing method according to the present invention will be described in more detail.

### Example 1

### 1. Manufacture of a Halogen-Free MXene

As a halogen-free etchant, 50 mL of NaOH aqueous solution with a saturated concentration of 27.5M was used to manufacture MXene with a molecular formula of Ti₃C₂Tₓ by heating a MAX phase material with a molecular formula of Ti₃AlC₂ in a hydrothermal reaction vessel at a temperature of 270° C. for 72 hours (First step).

### 2. Removal of Impurities in the Halogen-Free MXene

The manufactured MXene with the molecular formula Ti₃C₂Tₓ was post-treated (washed) at a room temperature for 5 minutes using phosphoric acid as a halogen-free post-treatment agent to remove impurities (Second step). In this case, the removed impurities were found to be aluminum hydroxide or NTO (Na—Ti—O) composites.

### 3. Manufacture of a Single Layer Halogen-Free MXene

A single layer halogen-free MXene (NaOH—Ti₃C₂Tₓ) was manufactured by adding TMAOH to the halogen-free MXene of the molecular formula Ti₃C₂Tₓ from which the impurities were removed and reacting the mixture at a temperature of 25° C. for 3 to 5 hours to exfoliate a multi-layer halogen-free MXene (Third step).

### Example 2

A single layer halogen-free MXene was manufactured in the same manner as in Example 1, except that a NaOH aqueous solution having a concentration of 20M was used as a halogen-free etchant during the process for manufacturing the halogen-free MXene.

### Example 3

A single layer halogen-free MXene was manufactured in the same manner as in Example 1, except that a NaOH aqueous solution having a concentration of 10M was used as a halogen-free etchant during the process for manufacturing the halogen-free MXene.

### Example 4

A single layer halogen-free MXene was manufactured in the same manner as in Example 1, except that a NaOH aqueous solution having a concentration of 5M was used as a halogen-free etchant during the process for manufacturing the halogen-free MXene.

### Comparative Example

A MXene (Minimally Intensive Layer Delamination MXene, MILD-Ti₃C₂Tₓ) was manufactured in the same manner as in Example 1, except that a HCl—LiF aqueous solution was used as an etchant during the process for manufacturing the halogen-free MXene.

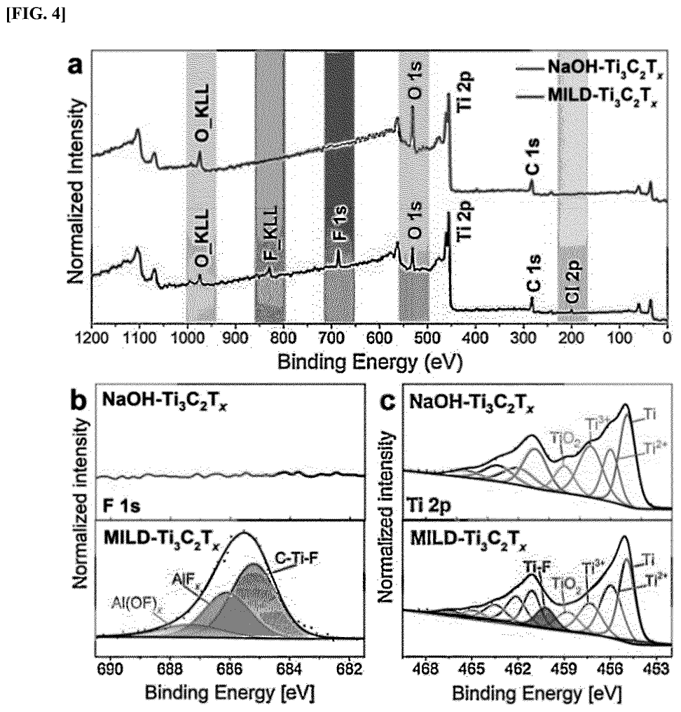

When comparing the halogen-free MXene of Example 1 with the MXene of the Comparative Example, as can be seen from the graphs of FIG. 4, the MXene of Example 1 was found not to contain any fluorine or chlorine as a result of quantitative analysis using an X-ray photoelectron spectroscopy (XPS). In addition, analysis of the Ti 2p peak in FIG. 4 indicated the characteristic deformation of the MXene material, which confirms that a stable MXene material has been synthesized. Moreover, high oxygen (O) contents of NaOH—Ti₃C₂Tₓ ((a) of FIG. 4) is an analysis result that confirms the influence of oxygen (O) present in the surface functional group rather than due to the production of TiO₂. This result is proven by the fact that the peak for TiO₂ (459 eV) is not large in the middle portion of the deformed Ti 2p ((c) of FIG. 4).

In the graph (a) of FIG. 4, a wide range of peaks of each MXene element appeared. There was no F peak in the MXene of Example 1, but the F peak appeared in the MXene of Comparative Example.

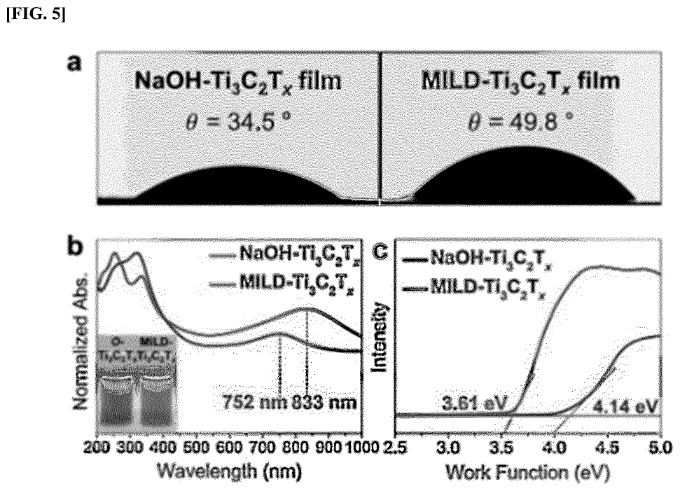

FIG. 5 are images (a) showing contact angle, a UV-vis absorption peak graph (b), and a Ultraviolet Photoelectron Spectroscopy graph (c) of a MXene surface produced by the process for manufacturing a halogen-free MXene according to Example.

Shown in (a) of FIG. 5 is a comparison of a degree of hydrophilicity of each MXene film by dropping water on each MXene film and measuring the contact angle. The MXene indicates different contact angles depending on the surface functional groups thereof. Shown in (b) of FIG. 5 is the UV-vis absorption peak of each MXene film. Also, (b) of FIG. 5 can be seen to indicate different peaks depending on the surface functional groups of MXene. Shown in (c) of FIG. 5 is UPS (Ultraviolet Photoelectron Spectroscopy) of each MXene film. Also, (c) of FIG. 5 can be seen to indicate different work function values depending on the surface functional groups of MXene.

Eventually, it can be seen from (a), (b), and (c) of FIG. 5 that even if MXene has the basic skeleton of Ti₃C₂ which is identical with each other, the surface characteristics of MXene change when the surface functional group (Tₓ) becomes different.

As a result of the film analysis, it can be confirmed through the analysis of contact angle (CA) that the MXene of Example 1 has no fluorine functional group and contains many —OH or —O— functional groups so that NaOH—Ti₃C₂Tₓ of Example 1 exhibits greater hydrophilicity than MILD-Ti₃C₂Tₓ of Comparative Example. In addition, when looking at (b) and (c) of FIG. 5, it can be seen that the MXene of Example 1 and the MXene of Comparative Example clearly show different peaks from the work function values by the analysis of the UV-vis absorption peak and the UPS.

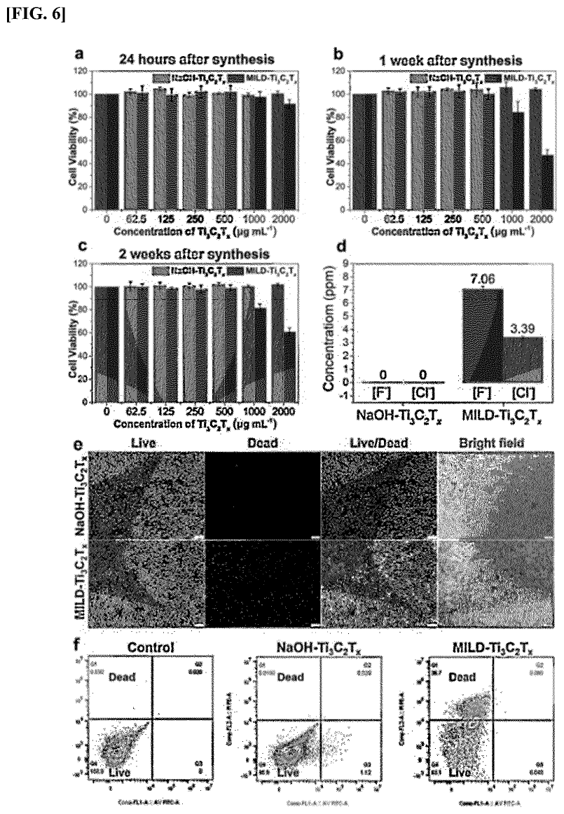

FIG. 6 discloses data such as halogen concentration graphs and graphs showing ion chromatograph values which indicate the results of biotoxicity experiments on the MXene (Example 1) manufactured by the process for manufacturing a halogen-free MXene according to the present invention and the conventional MXene (Comparative Example).

When looking at (a) of FIG. 6, it can be seen that there is almost no change in contents of the MXene of Example 1 and the MXene of Comparative Example for 24 hours after they are administered into living cells under in vitro condition. However, when looking at (b) and (c) of FIG. 6, it can be confirmed that a content of the MXene of Example 1 remains almost the same even after 1 week or 2 weeks, but a content of the MXene of Comparative Example decreases significantly as time of 1 week or 2 weeks elapse. In other words, it can be confirmed that the MXene of Example 1 has high biostability and can maintain a specific function while maintaining its content without being biodegraded even when more than 2 weeks have elapsed, but that the MXene of Comparative Example is biodegraded by oxidation after more than 1 week have elapsed, making it unable to perform the specific function.

Further, when checking (d) of FIG. 6, it can be confirmed that no toxic halogen elements such as fluorine (F) or chlorine (Cl) were detected from the MXene (NaOH—Ti₃C₂Tₓ) of Example 1 after administration to the human body, but that a significant amount of fluorine and chlorine are emitted from the MXene (MILD-Ti₃C₂Tₓ) of Comparative Example.

Shown in (e) and (f) of FIG. 6 is a state of cells when the cells were treated with the oxidized MXene of Example 1 and the MXene of Comparative Example under the condition similar to that of the human body for 72 hours. When comparing a state of the control cells (Control), which were not treated at all, with a state of the cells treated with the MXene of Example, it can be seen that they show almost similar activity states, but that a significant degree of cell death occurs in the cells treated with the MXene of Comparative Example.

FIG. 7 is UV-vis absorption peak graphs comparing oxidation stability on the MXene produced by the process for manufacturing a halogen-free MXene according to an embodiment of the present invention and the conventional MXene.

Shown in (a), (b), and (c) of FIG. 7 are the results of testing oxidation stability of the MXene of Example 1 and the MXene of Comparative Example by leaving them in a shaking incubator under the conditions of an atmospheric pressure and 37° C. similar to the body temperature. When looking at (a) of FIG. 7, it can be seen that the MXene of Example 1 shows almost similar ultraviolet absorption peaks even after 1 day, 1 week, and 2 weeks had elapsed, which shows that deformation of the MXene is maintained as it is. On the other hand, when looking at (b) of FIG. 7, the MXene of Comparative Example showed an absorption peak similar to that of the MXene of Example 1 up to 1 day, but showed a significant decrease in the absorption peak after a week. In other words, it can be confirmed that even if the MXene of Comparative Example is left in air for just one week, it is oxidized to produce TiO₂ and almost no deformation of the MXene molecules remains.

When looking at (c) of FIG. 7, it can be seen that the MXene of Example 1 has high oxidation stability with a very gradual decrease in the absorption peak of the MXene over a long period of time of about 700 hours, but that the absorption peak of MXene of Comparative Example decreases rapidly before 200 hours so that almost no deformation of the MXene molecule remains.

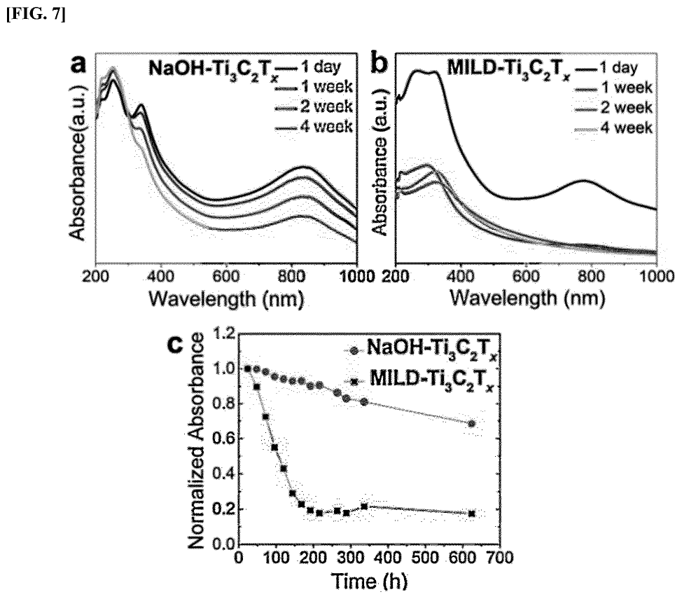

FIG. 8 is a table showing XRD graphs, peak areas, MXene contents, and the like which indicate a change in the crystal structures of MXene and MAX for checking an etched degree of a MXene surface over time in the process for manufacturing a halogen-free MXene according to an embodiment of the present invention.

That is, the table of FIG. 8 shows a transformation state of the MAX phase material to MXene according to the reaction time in the first step of mixing a saturated sodium hydroxide solution with the MAX phase material and heat treating them in the process of manufacturing the MXene of Example 1. It can be seen from FIG. 8 that a XRD peak area of the MXene (Ti₃C₂Tₓ) manufactured by performing a heat treatment process for 12 to 120 hours is gradually increasing, but that the peak area of the MAX phase material (Ti₃AlC₂) that has not been transformed to the MXene is gradually decreasing. In addition, it can be seen that the MXene content increases to 97.5% or more after 72 hours.

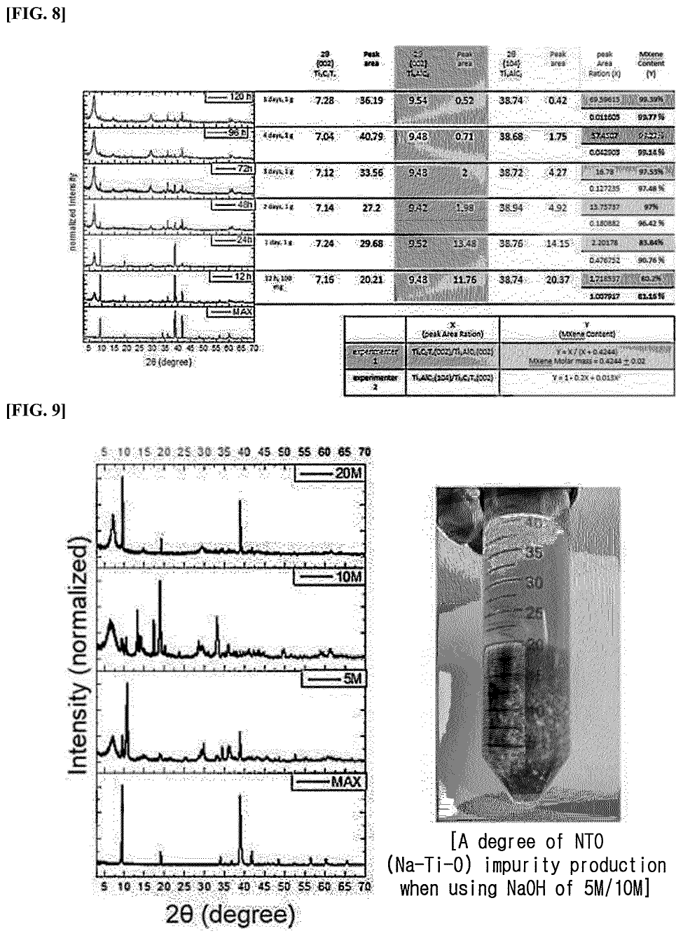

FIG. 9 is XRD graphs showing a degree of impurity production depending on a concentration of sodium hydroxide in the process for manufacturing a halogen-free MXene according to an embodiment of the present invention.

In FIG. 9, when looking at the XRD peak areas of the impurities generated after each MXene of Example 2 (heat treatment by mixing of the NaOH aqueous solution of 20M concentration), Example 3 (heat treatment by mixing of the NaOH aqueous solution of 10M concentration), and Example 4 (heat treatment by mixing of the NaOH aqueous solution of 5M concentration) was post-treated with a phosphoric acid post-treatment agent, it can be seen that they showed differences in a degree of etching depending on their concentrations, but clearly indicated that the etching was performed from the MAX phase to MXene.

Examples 3 and 4 were described to compare how the NTO contents changes depending on a concentration of NaOH used as the etchant. In Examples 3 and 4, the NaOH-MXene was synthesized using NaOH at a significantly lower concentration (5M, 10M) than the NaOH concentration of 27.5M used when originally synthesizing NaOH-MXene (the acid treatment (second step) was not performed). It was confirmed from Examples 3 and 4 that ratios of NTO impurities were higher.

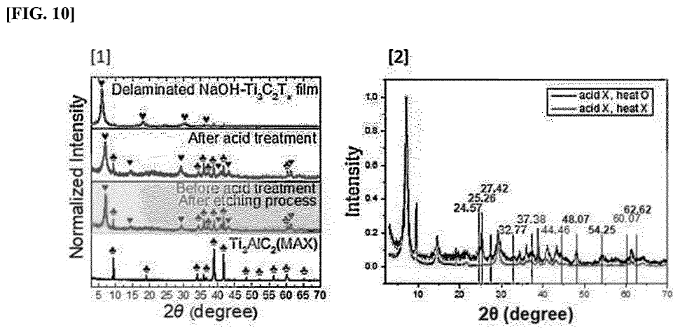

FIG. 10 is XRD graphs showing a change in the XRD peak of MXene at each step of synthesis in a process for manufacturing a halogen-free MXene according to an embodiment of the present invention.

Looking at overall change in the XRD peak (MAX→MXene) before and after etching of the MAX phase material, the peak change was not confirmed because there was no crystallinity of the NTO (impurities) before and after the acid treatment ([1]), which is a treatment process of the post-treatment agent. Therefore, after increasing crystallinity of the NTO through heat treatment in [2], the peak was reconfirmed. In addition, in [1], a change in the XRD peak before and after exfoliation of the MXene using TMAOH was confirmed.

The XRD peak ([2]) of NTO (impurities) before and after the acid treatment ([1]) and NTO (impurities) according to the presence or absence of heat treatment process to reconfirm the XRD peak after securing crystallinity of the impurities (NTO) without the acid treatment (through the heat treatment) was confirmed.

The graph [1] in FIG. 10 shows the XRD peak during the process for manufacturing MXene (NaOH—Ti₃C₂Tₓ) of Example 1 by subjecting the MAX phase material (Ti₃AlC₂) to the first step (using the saturated NaOH solution and heat treatment) and the second step (post-treatment using phosphoric acid), respectively, in the method for manufacturing a halogen-free MXene according to the present invention. It can be seen that as the MAX phase material (Ti₃AlC₂) is manufactured into the MXene (NaOH—Ti₃C₂Tₓ) of Example 1 through the first and second steps, the peak patterns continue to change so that the peak patterns of the MAX phase material (Ti₃AlC₂) and the MXene (NaOH—Ti₃C₂Tₓ) are clearly changed.

Herein, the black pattern indicates that only the etching of the first step was performed and no heat treatment was performed to ensure crystallinity of the NTO. The red pattern indicates that peaks (24.57-27.42) that appear to be the impurities were confirmed by heat treatment to increase crystallinity of the NTO after the etching of the first step.

Further, it can be confirmed from the graph [2] of FIG. 10 that comparison of the peak pattern (black pattern) when only the first step is performed for the MAX phase material (Ti₃AlC₂) with the peak pattern (red pattern) when neither the first step nor the second step are performed for the MAX phase material (Ti₃AlC₂) indicates that clearly different peak patterns (presumed to be the patterns of compounds containing Al element) are shown in the peak area (24.57˜27.42) in which specific elements exist.

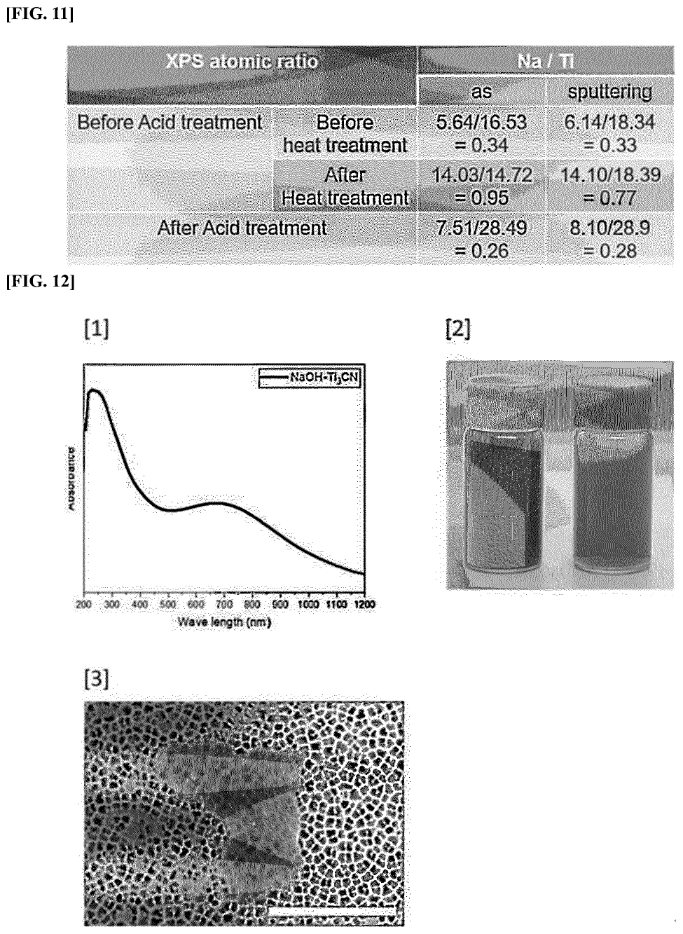

FIG. 11 is a table showing impurity contents before and after removal of impurities and before and after heat treatment in a process for manufacturing a halogen-free MXene according to an embodiment of the present invention.

The table of FIG. 11 shows the values resulting from confirming content ratios of the XPS impurity elements (Na, Ti), including the impurities identified in FIG. 10 through heat treatment, from before (as) sputtering and after sputtering through XPS (X-ray photoelectron spectroscopy) analysis, after treatment with a halogen-free etchant (first step) for the Max phase (Ti₃AlC₂) and then treatment with the etchant (first step) for checking a level of the impurities depending on the presence or absence of a halogen-free post-treatment agent (second step).

Looking at the results for the MXene (before heat treatment and before acid treatment) having many impurities, which was not subjected to the second step after treatment of the first step, the MXene (before acid treatment), which was subjected to additional heat treatment in the first step for checking the presence or absence of amorphous impurities, and the MXene (after acid treatment), by which the impurities were removed through the first and second steps, respectively, it can be confirmed that the ratios (0.26, 0.28) of the impurity elements (Na, Ti) on a surface of the MXene (after acid treatment) material that was subjected to both the first and second steps are detected lower than the ratios (0.34, 0.33) of the impurity elements (Na, Ti) on a surface of the MXene (before heat treatment) material that was not subjected to the second step after treatment of the first step and the ratios (0.95, 0.77) of the impurity elements (Na, Ti) on a surface of the MXene (after heat treatment) material that was subjected to additional heat treatment in the first step for checking the presence or absence of amorphous impurities. These results can be seen as proving that transformation of the MAX phase material (Ti₃AlC₂) into the MXene (NaOH—Ti₃C₂Tₓ), which was subjected to both the first and second steps, has effectively been performed.

Hereinafter, it is described that experimental results in which a MAX phase material other than the previously discussed MAX phase material (Ti₃AlC₂) is transformed to the MXene.

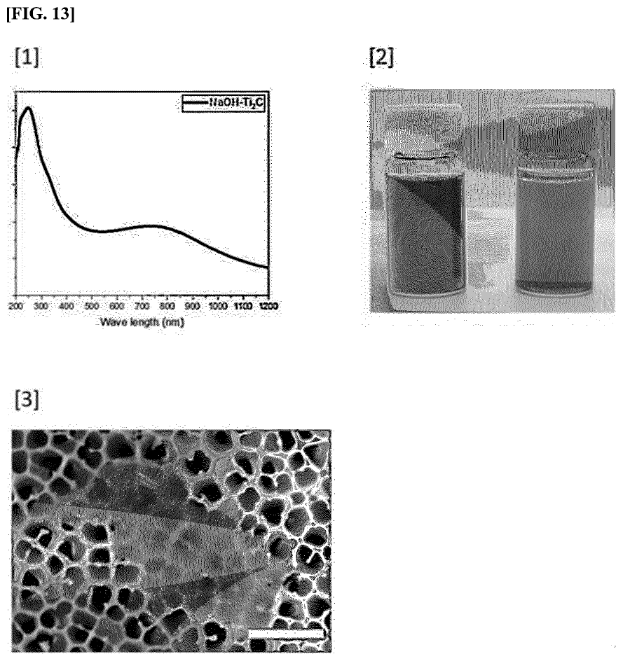

FIG. 12 is a UV-vis absorption peak graph [1], a photograph [2] of low/high concentration solutions, and a SEM image [3] which show the synthesis of NaOH—Ti₃CNTₓ MXene in the form of exfoliated flakes on Ti₃AlCN MAX phase where an element corresponding to A layer on the MAX phase is Al in the process for manufacturing a halogen-free MXene according to an embodiment of the present invention.

FIG. 12 is an analysis result for MXene (NaOH—Ti₃CNTₓ) manufactured from the MAX phase material (Ti₃AlCN) where the A layer exists as Al, other than the previously discussed MAX phase material (Ti₃AlC₂), by the process for manufacturing a halogen-free MXene according to an embodiment of the present invention.

The graph [1] of FIG. 12 is a UV-vis absorption peak graph of synthesized MXene (NaOH—Ti₃CNTₓ) using a UV-vis spectroscopy. When looking at a position of the peak shown in the graph [1] of FIG. 12, it can be seen that it is similar to the absorption position in FIG. 5b, which proves that the exfoliated MXene was synthesized since a unique peak of the MXene was observed.

The photograph [2] of FIG. 12 shows the synthesized MXene (NaOH—Ti₃CNTₓ) solutions. The left vial is the MXene solution of a high concentration, and the right vial is the MXene solution of a low concentration. The photograph proves that the MXene has been synthesized, considering that the dispersion state is good in the water dispersion phase.

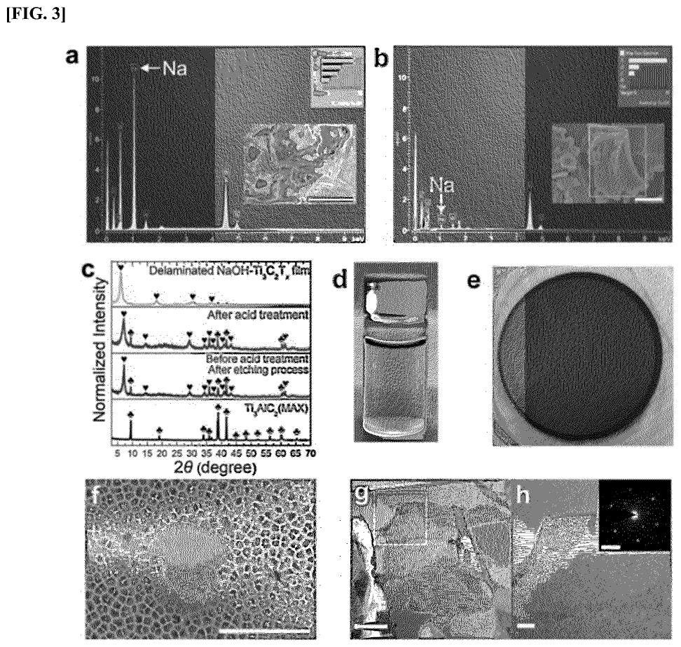

The SEM image [3] of FIG. 12 shows a single layer flake of the MXene observed by placing the synthesized MXene (NaOH—Ti₃CNTₓ) solution on an AAO membrane. When comparing the SEM image [3] of FIG. 12 and the SEM image (f) of FIG. 3, it can be seen that the two are similar to each other. The SEM image [3] of FIG. 12 is different from the multi-layered MXene image (b) of FIG. 3, which proves that the SEM image [3] of FIG. 12 has been synthesized in the form of exfoliated MXene with a two-dimensional plate-like structure. FIG. 13 is a UV-vis absorption peak graph [1], a photograph of low/high concentration solutions [2], and a SEM image [3] which show the synthesis of NaOH—Ti₂CTₓ MXene in the form of exfoliated flakes on Ti₃AlC₂ MAX phase where an element corresponding to A layer on the MAX phase is Al in the process for manufacturing a halogen-free MXene according to an embodiment of the present invention.

FIG. 13 is an analysis result for MXene (NaOH—Ti₂CNTₓ) manufactured from a MAX phase material (Ti₂AlC) where the A layer exists as Al, other than the previously discussed MAX phase material (Ti₃AlC₂), by the process for manufacturing a halogen-free MXene according to an embodiment of the present invention.

The graph [1] of FIG. 13 is a UV-vis absorption peak graph of synthesized MXene (NaOH—Ti₂CTₓ) using a UV-vis spectroscopy. When looking at a position of the peak shown in the graph [1] of FIG. 13, it can be seen that it is similar to the absorption position in FIG. 5b, which proves that the exfoliated MXene was synthesized since a unique peak of the MXene was observed.

The photograph [2] of FIG. 13 shows the synthesized MXene (NaOH—Ti₂CTₓ) solutions. The left vial is the MXene solution of a high concentration, and the right vial is the MXene solution of a low concentration. The photograph proves that the MXene has been synthesized, considering that the dispersion state is good in the water dispersion phase.

The SEM image [3] of FIG. 13 shows a single layer flake of the MXene observed by placing the synthesized MXene (NaOH—Ti₂CTₓ) solution on an AAO membrane. When comparing the SEM image [3] of FIG. 13 and the SEM image (f) of FIG. 3, it can be seen that the two are similar to each other. The SEM image [3] of FIG. 13 is different from the multi-layered MXene image (b) of FIG. 3, which proves that the SEM image [3] of FIG. 13 has been synthesized in the form of exfoliated MXene with a two-dimensional plate-like structure.

In conclusion, it can be confirmed that since the NaOH—Ti₃CNTₓ MXene and the NaOH—Ti₂CTₓ MXene also showed the SEM images of absorption peaks, water dispersion states, and single layer flakes similar to those of the MXene (NaOH—Ti₃C₂Tₓ) of Example 1, they had similar deformation of the halogen-free MXene.

That is, it has been demonstrated from FIGS. 12 and 13 that it is sufficiently possible to synthesize the exfoliated MXene of a two-dimensional plate-like structure from the MAX phase material in which the A layer is Al by the embodiments of the present invention, which can be seen as proving that the synthesis of various types of MXene is possible through the embodiments of the present invention. Furthermore, the embodiments of the present invention are not limited to the MAX phase material in which the A layer is Al, and it is possible to synthesize the exfoliated MXene of a two-dimensional plate-like structure from the various MAX phase materials according to the present invention.

The effects of the present invention obtained through the above-described solution are as follows.

Since the MXene is manufactured by performing the etching process to generate MXene from the MAX Phase material, and after the etching process, performing the impurity removal treatment process using the halogen-free etchant and the halogen-free post-treatment agent, a halogen functional group such as fluorine is not present on the surface of MXene not to have any harmful effects on the health of workers.

Due to the absence of the halogen functional group on the surface of MXene, the MXene has excellent chemical stability and oxidation stability and does not decompose easily over time to allow for long-term storage.

Even in case used in the electronic devices, the MXene does not cause contamination or malfunction of the devices due to halogen ions, and can be implemented as MXene which does not cause cytotoxicity even when applied to biological electronic devices such as biosensors.

The foregoing description is merely illustrative, and various modifications can be made without departing from the scope and technical spirit of the described embodiments by a person who has an ordinary knowledge in the technical field to which the present invention. The above-described embodiments can be implemented individually or in any combination.

What is claimed is:

1. A halogen-free MXene represented by the following formula (1), that has no halogen in its surface functional group by performing an etching process to generate MXene from a MAX Phase material, and after the etching process, performing an impurity removal treatment process of etching and removing impurities using a halogen-free etchant and a halogen-free post-treatment agent, respectively,
Mₙ₊₁XₙTₓ [Formula 1]
wherein, M is a transition metal element selected from the group consisting of Sc, Ti, V, Cr, Mn, Y, Zr, Nb, Mo, Hf, and Ta, X is at least one of carbon and nitrogen, and n is an integer from 1 to 4, and Tₓ is a functional group selected from the group consisting of oxygen, alkoxide of 1 to 5 carbon atoms, alkyl, carboxylate, hydroxide, hydride, oxide, sub-oxide, nitride, sub-nitride, sulfide, sulfonate, thiol, and epoxide.

2. The halogen-free MXene according to claim 1,
wherein the halogen-free MXene is formed of a single layer.

3. A method for manufacturing a halogen-free MXene, comprising:
a first step of mixing a halogen-free etchant with a MAX phase material and heat treating the same; and
a second step of removing impurities by treating a product obtained after the heat treatment with a halogen-free post-treatment agent.

4. The method for manufacturing the halogen-free MXene, according to claim 3,
wherein the MAX Phase material is a material represented by the following formula 2,
Mₙ₊₁AXₙ [Formula 2]
wherein, M is a transition metal element selected from the group consisting of Sc, Ti, V, Cr, Mn, Y, Zr, Nb, Mo, Hf, and Ta, and A is a metal element selected from the group consisting of Al, Si, P, Ga, Ge, As, Cd, In, Sn, Sb, Tl, and Pb, X is at least one of carbon and nitrogen, and n is an integer from 1 to 4.

5. The method for manufacturing the halogen-free MXene, according to claim 3,
wherein the first step includes etching the Max phase material at a high temperature of 200° C. or higher using the halogen-free etchant.

6. The method for manufacturing the halogen-free MXene, according to claim 5,
wherein the halogen-free etchant is a saturated sodium hydroxide solution with a concentration of 60 to 90%.

7. The method for manufacturing the halogen-free MXene, according to claim 3,
wherein the first step is performed at a temperature of 200 to 350° C. for a period of 24 hours or more to less than 96 hours.

8. The method for manufacturing the halogen-free MXene, according to claim 3,
wherein the second step is performed for 5 to 30 minutes using the halogen-free post-treatment agent selected from the group consisting of nitric acid, sulfuric acid, and phosphoric acid.

9. The method for manufacturing the halogen-free MXene, according to claim 3, further comprising:
after the second step, a third step of performing exfoliation of a single layer by adding an organic solvent selected from the group consisting of DMSO (Dimethylsulfoxide), TMAOH (Tetramethylammonium hydroxide), and TBAOH (Tetrabutylammonium hydroxide) to the halogen-free MXene from which the impurities have been removed.

10. The method for manufacturing the halogen-free MXene, according to claim 9,
wherein the third step is performed at a temperature of 25 to 45° C. for 3 to 5 hours.
